(19) United States
(12) Patent Application Publication
(10) Pub. No.: US 2017/0043896 A1
(43) Pub. Date: Feb. 16, 2017

(54) AUTOMATED MACHINE FOR ASSEMBLING ORAL MEDICAMENT DISPENSERS

(71) Applicant: Leopoldo Meneses Fernandez, Mexico City (MX)

(72) Inventor: Leopoldo Meneses Fernandez, Mexico City (MX)

(21) Appl. No.: 15/306,103

(22) PCT Filed: Apr. 24, 2014
(86) PCT No.: PCT/MX2014/000063

§ 371 Date: Oct. 23, 2016

(30) Foreign Application Priority Data
Jun. 5, 2014 (EP) 14001948.0

(51) Int. Cl. B65B 57/00; B65B 35/14; B65B 35/26; B65B 63/08; A61J 7/00; B65B 5/04

(52) U.S. Cl. CPC B65B 57/00; A61J 7/0053; B65B 5/04; B65B 35/26; B65B 63/08; B65B 35/14

(57) ABSTRACT

An automated machine for assembling an oral medicament dispenser comprising a combination of special items such as: a programmable logic controller, compressed air, position sensors, actuators or mini carriages, valves, automatic vibratory feeders, said machine avoids handling of all and each one of the components by a large number of operators and reduces the impact on the operating times and production costs, applying a set of processes that are necessary for assembling the oral medication dispenser, for the compliance of the processes starting by the vibratory feeders wherein each component travel through tracks in line and curve to support the flow of the product as it moves through its parts and even with the support of air jets and supports, wherein the components arrive to the tables having two rotating plates each having cavities conveyor plates in said plates are located eight stations in which are performed a set of processes such as loading components, torching, siliconizing, flaming, partial insertion and full insertion of all and each one of the components until obtain the desired oral medication dispenser, which is discharged to a conveyor belt that transport said dispenser to the finished product container.

### FIELD OF THE INVENTION

The present invention refers to a machine for the assembly of an oral medicament dispenser. Specifically to an automated modular machine of high precision which increase productivity, reduce time, space and costs.

### BACKGROUND OF THE INVENTION

Actually, there are several methods and forms for assembling oral medicament dispensers of the syringe type with or without inverted. This kind of methods are generally carried out manually which requires a large investment of time for having large batches of assembled dispensers or finished product, likewise, this kind of processes or assembling methods are very susceptible of human mistakes which decreases the product quality. Similarly, this kind of methods can cause that one or more components of the product are contaminated of in case that an employee is ill and is in direct contact with the components during their assembly or due to lack of hygiene despite using protection equipment such as gloves, headgear, facemasks, Filipino and antistatic pants, etc. and thus, according to the previous details a high impact on operating times and production costs is generated, fully affecting the delivery date agreed with customers.

Similarly, there are assembling machines, however in said machines the product is handled by a large number of operators to comply in a timely manner all and each one of the processes that are necessary for assembling an oral medicament dispenser, which as in the manual processes there are production delays due to a lot of reasons, some of them such as the personnel absence, failures in tools or devices and sometimes due to the work environment itself. On the other hand, it is also caused a high percentage of defects by mis-operation of the components of the oral medicament dispenser, moreover it causes the contamination of the oral medicament dispenser due to direct contact having the operator.

Equally, there are also assembling processes by a production or assembly line, which requires a precinct or room of large proportions since in each assembly station huge devices as well as endless belts for transporting each component to each station are used. Also, when the assembly of oral medicament dispensers without inverted or different volume capacities is required, it is necessary to stop the entire production, to modify the assembly line in order to remove or withdraw the station of placement of the inverted, or to change the components of said production line to assemble dispensers of another volume capacity, which generates delays in deliveries and a great waste of time and resources between the production of each dispensing oral medicament.

As reference, the Mexican patent MX 220843, discloses an intermittent machine horizontal rotation for manufacturing syringes from a plurality of glass tubes vertically fed, comprising a first machine section which rotates intermittently towards a plurality forming stations, having: a stationary machine frame; a rotating machine frame, rotating intermittently and horizontally about a vertical axis of actuating means mounted on the stationary machine frame, to a plurality of forming stations; a plurality of holding means for continuous rotation glass tubes, each mounted equidistantly around the carrying means, which rotate continuously about a vertical axis to receive and retain rotatably a vertical glass tube; a plurality of burning means, each mounted stationarily around the stationary machine frame in a forming station providing a flame jet to open a closed end of a glass tube, to heat and soften a lower end of the glass tube, for finishing at fire a tip portion for needle at the lower end of the glass tube and to cut a syringe body of the glass tube; and rotating tip finishing means horizontally and rotationally mounted on the stationary machine frame in a tip forming station to form a tip for receiving a needle, at the lower end of the glass tube; and a second machine section which rotates intermittently and horizontally towards a plurality of stations and having: a stationary machine frame; a horizontal rotary machine frame, rotating intermittently and horizontally about a vertical axis of the actuating means mounted on the stationary machine frame, to a plurality of forming stations; a plurality of continuous rotation fastener means, each equidistantly mounted around the horizontal rotary machine frame, continuously rotating on a vertical axis for rotatably receiving and retaining a vertical syringe body and releasing a finished syringe body; a plurality of burning means, each stationarily mounted around the stationary machine frame in a forming station for heating and softening an upper closed end of the syringe body, opening the upper closed end of the syringe body, forming a flat retention flange perpendicular to an upper end of the syringe body and finishing at fire the newly formed retention tab.

A disadvantage of the Mexican patent MX 220843 lies in the implementation of a large number of elements required for the manufacture of syringes; likewise, it requires a heating mechanism providing a flame jet to open a closed end of a glass tube, to heat and soften a lower end of the glass tube, to finish at fire a tip portion for needle at the lower end. Thus, this Mexican patent is focused on an entirely different objective to that of the present invention; equally by requiring a large number of specific elements, there is an increase of costs and time. Therefore, an automated machine covering these drawbacks effectively, safely and reliably is required.

### OBJECTS OF THE INVENTION

It is therefore an object of the present invention to provide an automated machine for assembling an oral medicament dispenser, which avoids components handling by a large number of operators reducing the impact on operating time and production costs.

A further object of the present invention is to provide a high precision automated machine at a level of thousandths of millimeter for dispensing medicament in a precise manner in the required time.

Yet another object of the present invention is to provide an automated machine of the modular type that can be used in a reduced space.

Another object of the present invention is to provide an automated machine that can be able of assembling an oral medicament dispenser with or without inverted, without the need to change or replace numerous components.

Another object of the present invention is to provide an automated machine for assembling an oral medicament dispensers, which can be able of assembling automatically various presentations of dispensers such as oral medicament dispensers of different volume capacities without changing or replacing a large number of components.

Yet another object of the present invention is to provide a process for assembling an oral medicament dispenser, resulting highly productive by being a continuous process.

### BRIEF DESCRIPTION OF THE INVENTION

These and other objects are achieved by an automated machine for assembling an oral medicament dispenser comprising in essence a pair of tables which comprise each a rotary plate respectively, for receiving separately the components of the oral medicament dispenser through four vibratory feeders, which are disposed in a modular or planetary manner around said pair of central tables, said vibratory feeders comprise a track in line and curve to feed the respective component of the oral medicament dispenser to the corresponding table. Each rotating plate of each table comprises a plurality of workstations pneumatically actuated, in which a sets of necessary processes for assembling an oral medicament dispenser (E) are applied and which are located on the periphery of said rotating plates, wherein the first table comprises the stations for carrying out the processes of: loading component A (Syringe with pivot); torching the internal walls of component A (Syringe with pivot); siliconizing the internal walls of component A (Syringe with pivot); loading and inserting partially of component B (Plunger or piston) into component A (Syringe with pivot); inserting fully component B (Plunger or piston) into component A (Syringe with pivot); flaming component A (Syringe with pivot) and component B (Plunger or piston) already assembled; inserting component C (adapter or Inverted) in the pivot of component A (Syringe with pivot) with component B (Plunger or piston) inserted into the same component, together with the corresponding station of the table B; indicating the machine that previous processes have been completed and that it is possible to start another cycle of processes from the beginning.

As to the second table, this comprises stations for carrying out the processes of: loading component C (adapter or Inverted); loading component D (housing or hood having a bullet or flat shape) on the conveyor plate of cavities with the fitting diameter faced upward; indicating the machine that processes performed in the previous stations have been completed and it can start a new loading and partial insertion process of component C (adapter or Inverted) and component D (housing or hood having a bullet or flat shape); inserting component C (adapter or Inverted) into the pivot of component A (Syringe with pivot) with component B (Plunger or piston) inserted therein; inserting partially component D (housing or hood having a bullet or flat shape) with component A (Syringe with pivot), component B (Plunger or piston) and component C (adapter or Inverted) already assembled; inserting fully component D (housing or hood having a bullet or flat shape) with component A (Syringe with pivot), component B (Plunger or piston) and component C (adapter or Inverted) already assembled; indicating the machine than previous processes have been completed and that a the last process of downloading and transport of the oral medicament dispenser (E) already totally assembled can be performed and in the container of finished product.

### BRIEF DESCRIPTION OF THE DRAWINGS

The novel aspects that are considered characteristic of the present invention are established with particularity in the appended claims. However, the operation, together with other objects and advantages thereof, will be better understood in the detailed description of a specific embodiment, when it is read in conjunction with the accompanying drawings, in which:

FIG. 1 shows a sets of views in front plan and cross-sectional of the oral medicament dispenser system, which is assembled in the automated machine of the present invention.

FIG. 2 shows perspective views of the oral medicament dispenser system, which is assembled in the automated machine of the present invention.

FIG. 3 shows a perspective view of the automated machine of the present invention.

FIG. 4 shows a plan top view of the automated machine for assembling the oral medicament dispenser.

FIG. 5 shows a plan top view of the processes applied in each one of the rotating plates of the automated machine for assembling the oral medicament dispenser.

FIG. 6 shows a perspective view of the vibratory feeder of component A (Syringe with pivot).

FIG. 7 shows a perspective view of the tables together with the two rotary plates, and the conveyor bases.

FIG. 8 shows a perspective view of the mini-carriage or actuator and parallel grippers oriented to hold the component A (Syringe with pivot) of the oral medicament dispenser.

FIG. 9 shows a perspective view of the torching process, applied to the internal walls of component A (Syringe with pivot) of the oral medicament dispenser.

FIG. 10 shows a perspective view of siliconizing process applied to the internal walls of component A (Syringe with pivot) of the oral medicament dispenser.

FIG. 11 shows a perspective view of the mini-carriage or actuator and vacuum generators holding component B (Plunger or piston) of the oral medicament dispenser.

FIG. 12 shows a perspective view where the partial insertion of component B (Plunger or piston) with component A (Syringe with pivot) oral medicament dispenser observed.

FIG. 13 shows a perspective view wherein it is depicted the full insertion of component B (Plunger or piston) with component A (Syringe with pivot) of the oral medicament dispenser.

FIG. 14 shows a perspective view wherein it is depicted the flaming process of component A (Syringe with pivot) assembled with component B (Plunger or piston).

FIG. 15 shows a perspective view of the mini-carriage or actuator and vacuum generators holding component B (Plunger or piston) of the oral medicament dispenser.

FIG. 16 shows a perspective view of the mini-carriage or actuator inserting direction to insert component C (adapter or inverted) into the cavities of the conveyor plate.

FIG. 17 shows a perspective view of the divider plates that rotate 180 degrees to place the component D in the correct position (housing or hood having a bullet or flat shape) of the oral medicament dispenser.

FIG. 18 shows a perspective view wherein it is depicted, component A (Syringe with pivot), component B (Plunger or piston) and component C (adapter or reversed) already assembled for partial insertion into the component D (housing or hood having a bullet or flat shape).

FIG. 19 shows a perspective view wherein the full insertion of component D (housing or hood having a bullet or flat shape), with component A (Syringe with pivot), component B (Plunger or piston) and component C (adapter or inverted).

FIG. 20 shows a perspective view wherein it is depicted the oral medicament dispenser already assembled, for carrying out the downloading process of the oral medicament dispenser.

FIG. 21 shows the operation of the actuators or mini cars, activated by two motion sensors SPI and SPF, the first motion sensor SPI is located at the proximal end of the actuator or mini car, the second motion sensor SPF is located at the distal end of the actuator or mini car.

FIG. 22 shows a PLC (Programmable Logic Controller) programmed with logical sequence; this system is located inside a control board which is controlled by a touch screen monitor.

### DETAILED DESCRIPTION OF THE INVENTION

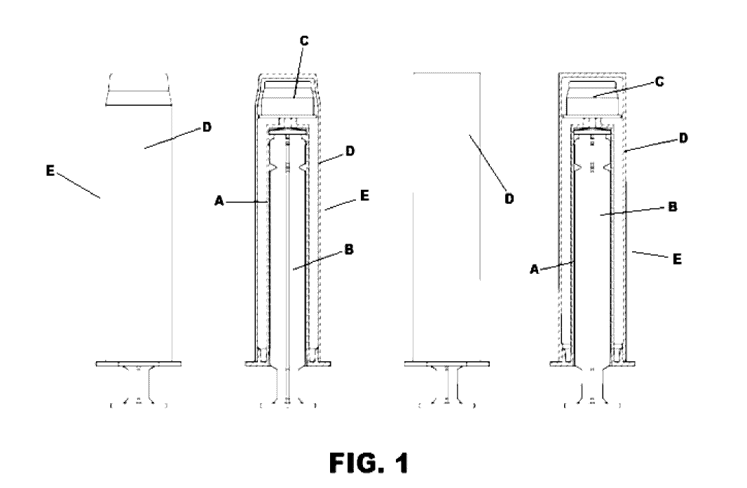

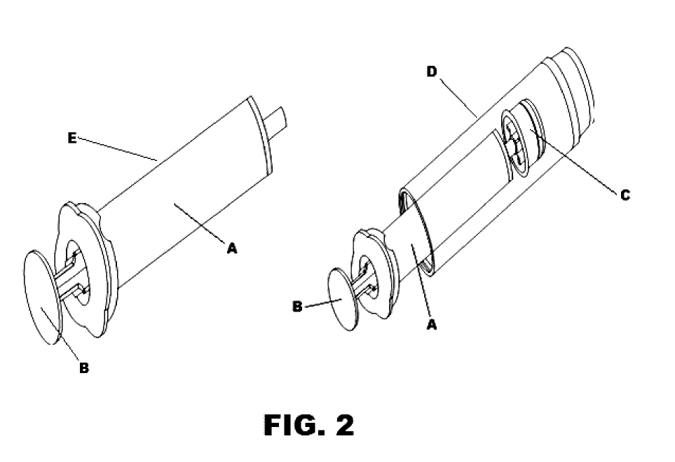

With respect to FIGS. 1 and 2, it is shown generally an oral medicament dispenser E which is conformed by component A which is a syringe with pivot, a component B which is a plunger or piston, a component C which is an adapter or inverted, and a component D which is a housing or hood having a bullet or flat shape. Said FIG. 2 illustrates the components A, B, C and D in their assembled state to finally obtain the oral medicament dispenser E.

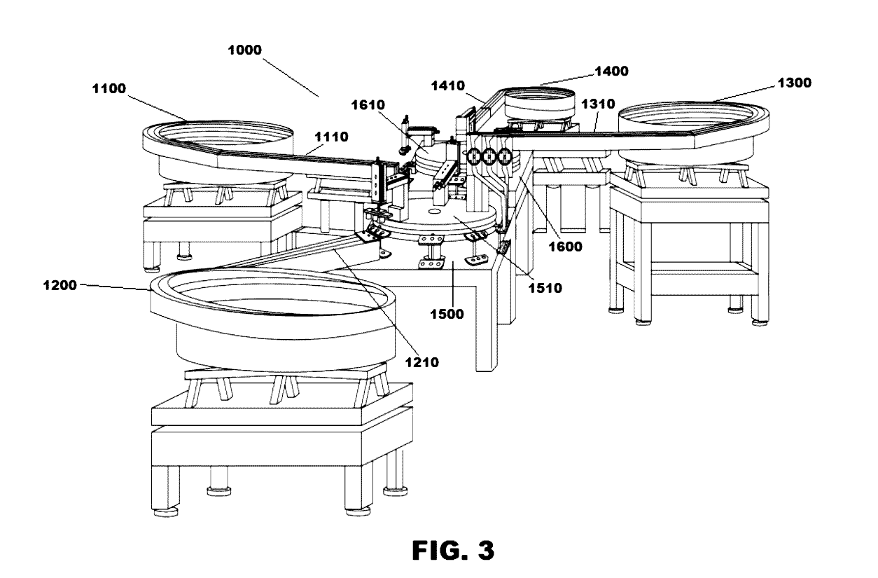

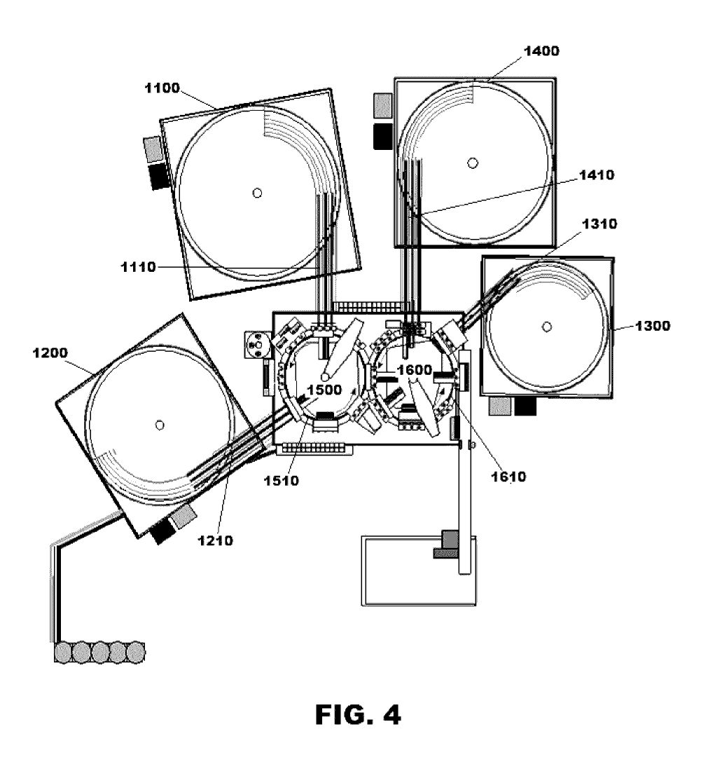

Referring now to FIGS. 3 and 4, it is shown the assembling machine of oral medicament dispensers generally numbered in 1000. Said assembling machine 1000 of oral medicament dispensers E comprises a pair of central tables 1500 and 1600 each comprising a rotary plate 1510 and 1610 respectively, for receiving said components A, B, C and D from the corresponding vibratory feeders; four vibratory feeders 1100, 1200, 1300 and 1400 which are disposed in a modular or planetary manner around the pair of central tables 1500 and 1600, wherein said vibratory feeders, are conformed as follows: a vibratory feeder for component A (syringe with pivot) 1100, a vibratory feeder for component B (Plunger or piston) 1200, a vibratory feeder for component C (adapter or inverted) 1300 and a vibratory feeder for component D (housing or hood having a bullet or flat shape) 1400, each of said vibratory feeders 1100-1400 includes a track in line and curve 1110, 1210, 1310 and 1410 to feed the respective components A and B to table 1500 and the respective components C or D to table 1600.

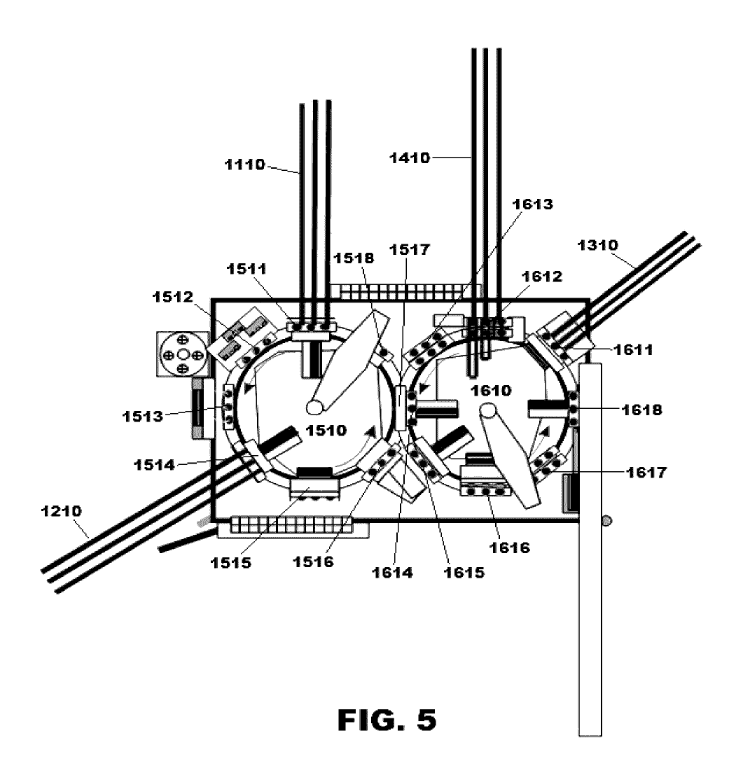

With respect to FIG. 5, it is shown in a top view of the assembling machine 1000 of oral medicament dispensers, wherein it is shown that each table 1500 and 1600 comprises a plurality of workstations pneumatically actuated, in which a sets of necessary processes for assembling oral medicament dispenser (E) are applied and which are located on the periphery of said rotary plates 1510 and 1610 respectively.

With respect to table 1500, said table 1500 comprises the following stations: a Station 1511 in which together with the vibratory feeder 1100, and by means of the track in line and curve 1110 the loading process of component A (Syringe with pivot) is performed; a Station 1512 wherein the torching process to the internal walls of component A (Syringe with pivot) is performed; a Station 1513 wherein the siliconizing process to the internal walls of component A (Syringe with pivot) is performed; a Station 1514 in which along with the vibratory feeder 1200 and by means of the track in line and curve 1210 the loading and partial insertion process of component B (Plunger or piston) into component A (Syringe with pivot) is performed; one station 1515 wherein the process of full insertion of component B (Plunger or piston) into component A (Syringe with pivot) is performed; a Station 1516 wherein the flaming process to component A (Syringe with pivot) and component B (Plunger or piston) already assembled is performed; a Station 1517 where the conveying process of the parts of the rotating plate (1510) to the rotating plate (1610) is performed, wherein in the same conveying process the insertion of component C (adapter or Inverted) on the nozzle component A (Syringe with pivot) with the component B (Plunger or piston) into the same is made; and a Station 1518 in which any process is generated, since this station is maintained free indicating the machine that the processes performed in the stations 1511-1517 have been completed and that another cycle of processes can be started from the station 1511 with loading process of a new component A (Syringe with pivot).

With respect to table 1600, said table comprises the following stations: a Station 1611 in which together with the vibratory feeder 1300, and by means of the track in line and curve 1310 the loading process of component C (Adapter or Inverted); is carried out; a Station 1612 in which together with the vibratory feeder 1400, and by means of the track in line and curve 1410 the loading process of component D (housing or hood having a bullet or flat shape) is carried out on the conveyor plate of cavities 1640, with the fitting diameter upward oriented; a Station 1613 in which any process is generated, wherein this station is maintained free in order to indicate the machine that processes performed in stations 1611 and 1612 have been completed and that a new process of loading and partial insertion of component C (Adapter or Inverted) can be started, as well as a new process of loading and partial insertion of component D (housing or hood having a bullet or flat shape); a Station 1614 wherein the insertion process of component C (adapter or inverted) onto the nozzle of component A (Syringe with pivot) with the component B (Plunger or piston) within the same is performed, for this process said station 1614 is related with the station 1517, generating the transfer of the parts from the rotating plate 1510 to the rotating plate 1610; a Station 1615 wherein the process of partial insertion of component D (Housing or hood having a bullet or flat shape) with component A (Syringe with pivot), component B (Plunger or piston) and component C (adapter or Inverted performed) already assembled is carried out; a station 1616 wherein the process of full insertion of component D (Housing or hood having a bullet or flat shape) with component A (Syringe with pivot), component B (Plunger or piston) and component C (adapter or Inverted performed) already assembled is carried out; a station 1617 in which any process is generated, this station is maintained free indicating the machine that the processes 1614 to 1616 have been completed and that the last process in station 1618 can be performed; and a station 1618 wherein the process of transferring and downloading the oral medicament dispenser (E) fully assembled is performed, said dispenser is downloaded on the conveyor belt that goes toward the finished product container.

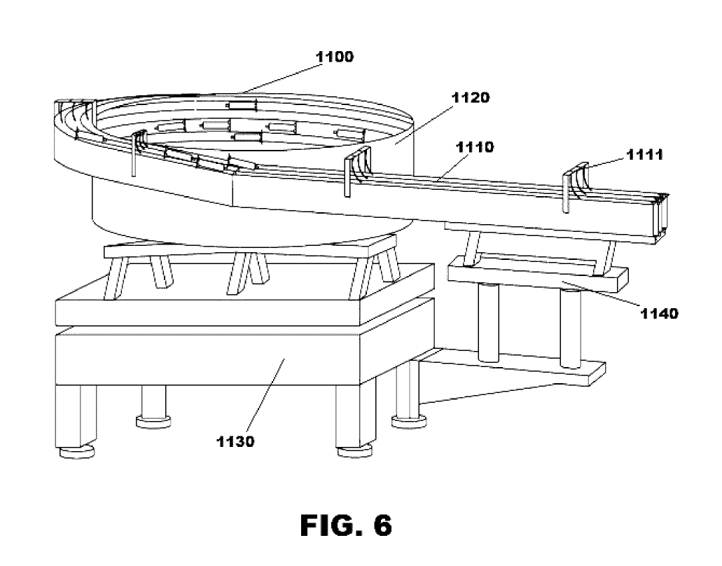

Referring now to FIG. 6, it is shown the general configuration of vibratory feeders 1100-1400, wherein they will be only described with respect to the vibratory feeder 1100, since vibratory feeders 1200-1400 have the same elements and configuration, said vibratory feeder 1100 is conformed by a substantially cylindrical hopper 1120, tracks in line and curve 1110 to support the product flow while it is moved through its parts by vibration, said feeder 1110 also comprises special coatings that help to avoid traction, damages in product and a reduction in noise levels, and even more for a better efficiency in the supply of components, said tracks in line and curve 1110 further comprise air jets and supports 1111 whose function is to push the components with the same air force. Likewise, said hopper 1120 and tracks in line and curve 1110 are supported by means of a support table 1130 and tubular supports 1140, which are embedded or fixed on a solid base, which is supported at one point on the same table.

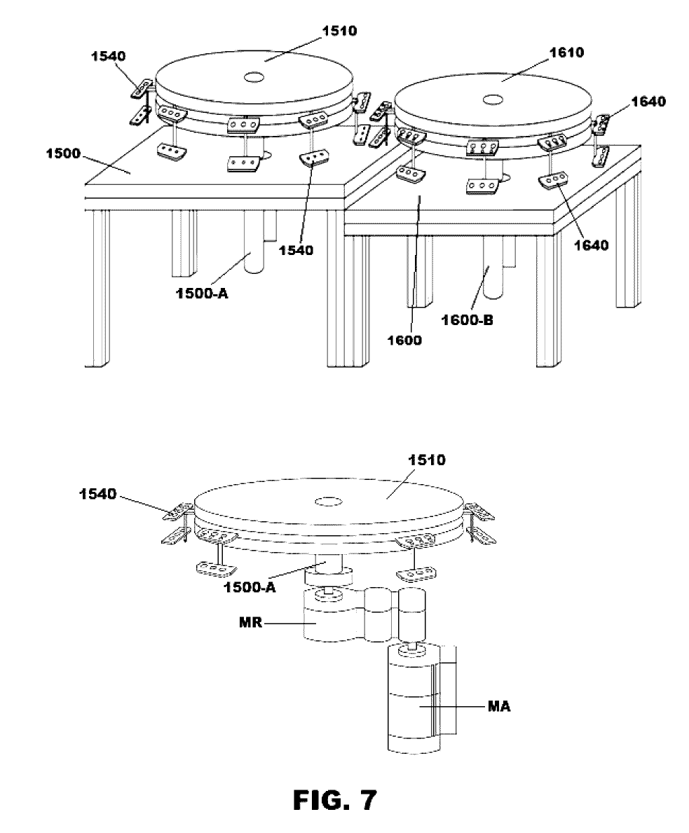

Referring now to FIG. 7, it is shown the general configuration of the central tables 1500 and 1600, which in the preferred embodiment have a substantially square shape, however they may have any other shape without departing from the scope of the present invention, said central tables 1500 and 1600 are located adjacent one to another and offset in height to their interaction during the assembling process. Each of said central tables 1500 and 1600 comprises a rotating plate 1510 and 1610 respectively, which are attached to said tables 1500 and 1600 in a rotatable manner by means of an axis 1500A and 1600A respectively. Said rotating plates comprise a plurality conveyor plates of cavities 1540 and 1640, which correspond to each workstation 1511-1518 and 1611-1618 for performing each process.

Equally, in said FIG. 7 the actuating of the rotating plates 1510 and 1610 which perform movements of 45° through the axes 1500A and 1600A is shown, wherein each movement or rotation is effected each time that the last of the processes of each of said rotating plates 1510 and 1610 is performed, which rotate at the same time and at the same speed, independently each one rotate by means of a reduction unit MR which is coupled to a standardized asynchronous motor MA this system is located below each table 1500 and 1600, as shown in said FIG. 7.

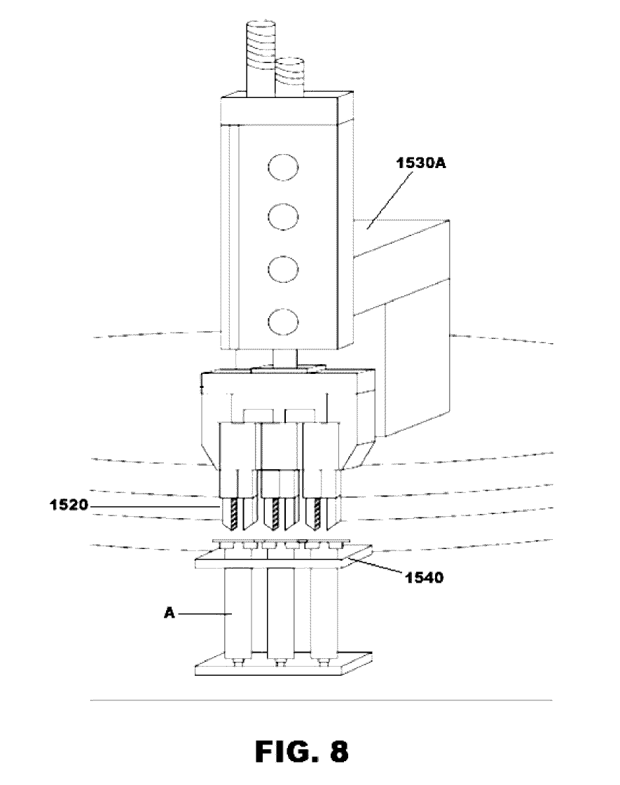

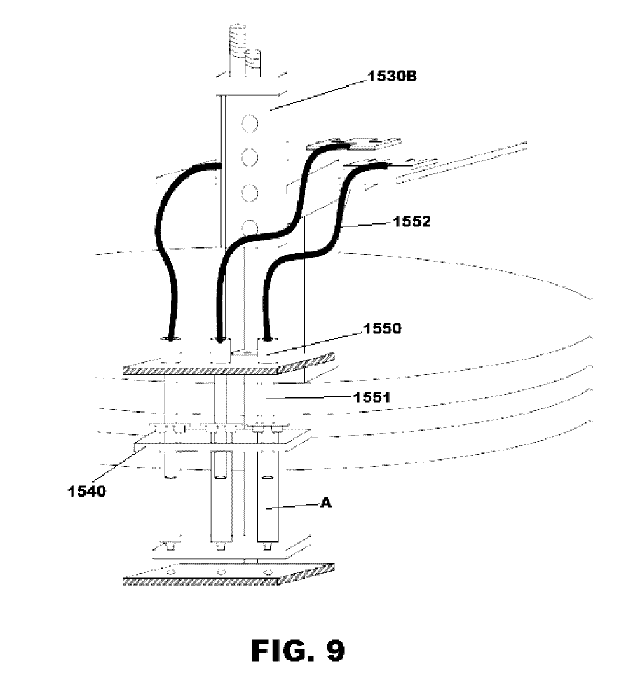

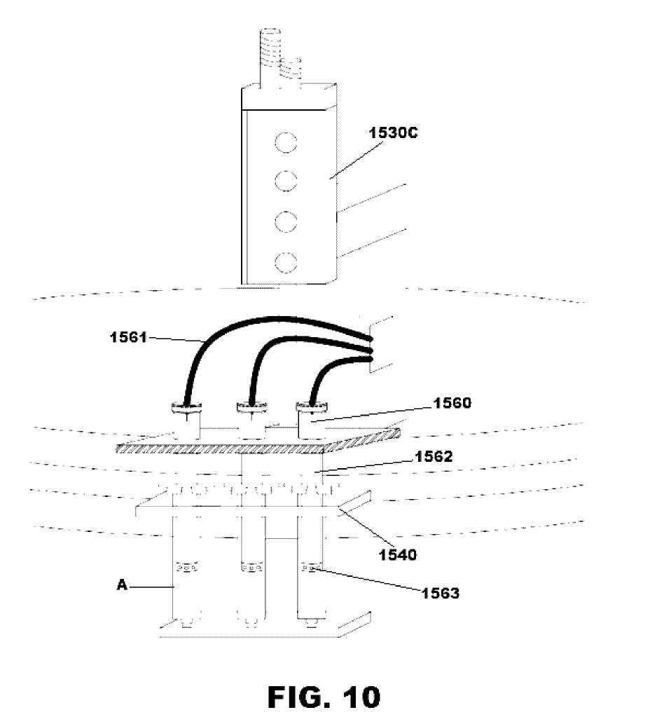

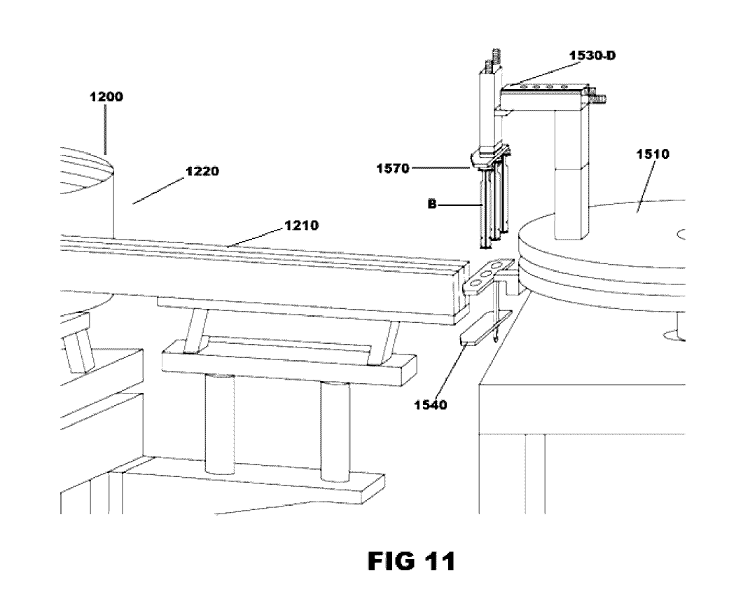

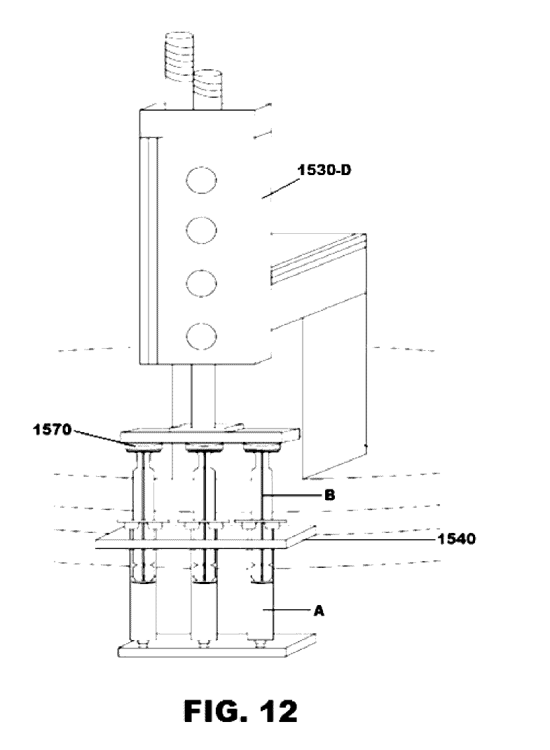

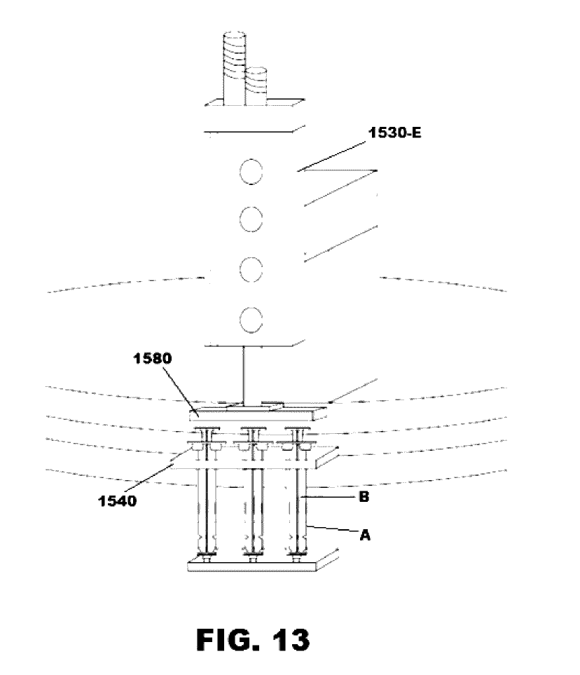

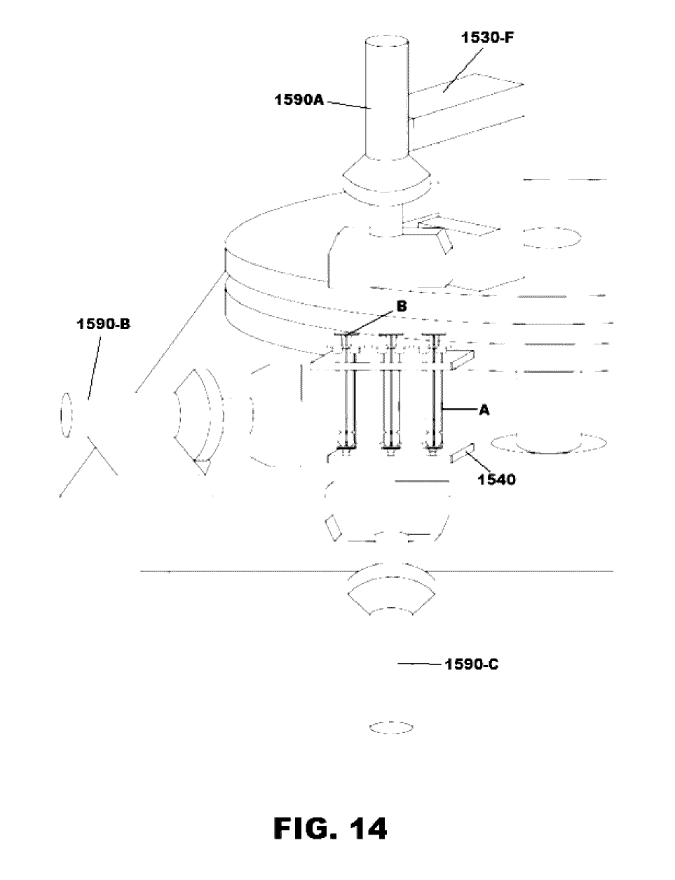

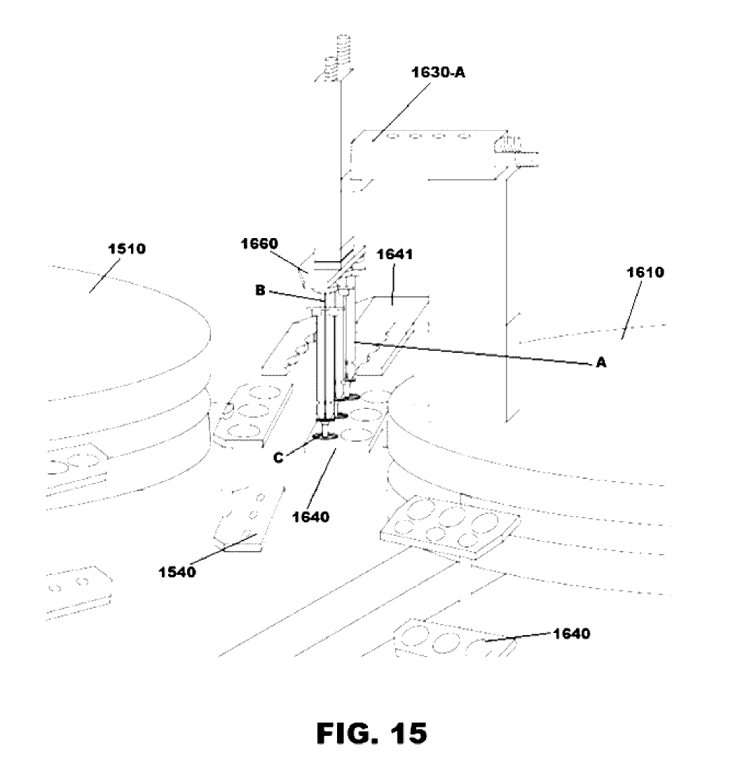

With reference to FIGS. 8 to 15 the processes of assembly and operation of the machine in the rotating table 1510 is shown, wherein in a first phase of the assembling process the first process is performed at Station 1511 together with the vibratory feeder 1100 as shown in FIG. 8, in which the loading process of component A (Syringe with pivot) is performed by means of a parallel grippers 1520 which hold internally said component A (Syringe with pivot), once said component is gripped, the same is raised by a pair of actuators or mini-carriages 1530A placing said component A on the cavities conveyor plate 1540 as shown in FIG. 8; once placed components A on the plate 1540, these are transported by an counterclockwise rotating movement of the rotary plate 1510 to station 1512 to perform the torching process as shown in FIG. 9, which basically refers to the application of ionized air to the internal walls of component A (Syringe with pivot), said ionized air is applied to said internal walls by means of blowers 1550 through nozzles 1551, said ionized air is fed to said blowers 1550 through flexible conduits 1552, wherein during said torching process, the nozzles are lowered by an actuator or mini-carriage 1530B and blow said ionized air into the component A (Syringe with pivot); once performed the torching process, the components A are transported rotationally in a counterclockwise manner to the station 1513 to carrying out the siliconizing process to the internal walls of the components A (Syringe with pivot) as shown in FIG. 10, the application of silicone is carried out by means of spray valves 1560 which are fed by said flexible conduits 1561, wherein the silicone flows through said spray valves via an inner conduit and is dispersed to the inner walls of the component A (Syringe with pivot) by a plurality of ports or holes 1563, said valves are descended by an actuator or mini-carriage 1530C and apply a light coating of silicone into the component A (Syringe with pivot); subsequently, the process of loading and partial insertion of component B (Plunger or piston) at station 1514 is carried out, wherein together with the vibratory feeder 1200 as shown in FIG. 11, it is performed the load and partial insertion of component B (plunger or piston) as shown in FIGS. 11 and 12, wherein said component B is placed and partially inserted into the component A (Syringe with pivot) which has been transported rotationally on the cavities conveyor plate 1540 by the rotational plate 1510, said process is performed firstly by a sets of vacuum generators 1570 which hold and transport, by means of the actuator or mini-carriage 1530D, the component B (plunger or piston) from the tracks in line and curve 1210, towards component A (Syringe with pivot) and secondly by partially inserting said component B into said component A; further, said components A and B partially coupled or inserted are transported by the cavities conveyor plate 1540 to station 1515 to perform the process of full insertion of component B (Plunger or piston) into component A (Syringe with pivot) as shown in FIG. 13, this process is performed by a plate 1580 which lowered by an actuator or mini-carriage 1530E and generates the full insertion of component B (Plunger or piston) into component A (Syringe with pivot); subsequently, the components A and B already fully assembled are transported to station 1516 to perform the flaming process to said components A and B already assembled as shown in FIG. 14, said flaming process is applied by heat guns 1590A to 1590C to the outer walls of the components in its upper, lower and central parts; subsequently the process of inserting the component C (adapter or Invested) at Station 1517 is performed, wherein the transfer of component A (Syringe with pivot) with component B (Plunger or piston) already assembled is carried out, said transporting is performed from the rotating table 1510 to the rotating plate 1610 together with the process of station 1614, wherein the insertion of component C (adapter or inverted) onto the nozzle or pivot of component A (Syringe with pivot) with component B (Plunger or piston) already assembled is performed, as shown in FIG. 15, which have been transported by the cavities conveyor plate 1540 and the rotating table 1510, said component A (Syringe with pivot) and said component B (Plunger or piston) already assembled from station 1517 are taken from the cavities conveyor plate 1540 by a sets of vacuum generators 1660, then they are transported toward the rotating plate 1610 placed on the table 1600, then said assembled components A and B are placed and inserted into the component C (adapter or Inverted) located on a cavities conveyor plate 1640, which has transported the component C (adapter or inverted) which come from the loading and insertion process of component C (adapter or Invested) of station 1611; finally in this table 1500, the processes and assemblies are finished at station 1518, which any process is generated since as mentioned above, this station is maintained free to indicate the machine that processes 1511 to 1517 have been completed and that it is possible the start of another cycle of processes and assemblies from the station 1511.

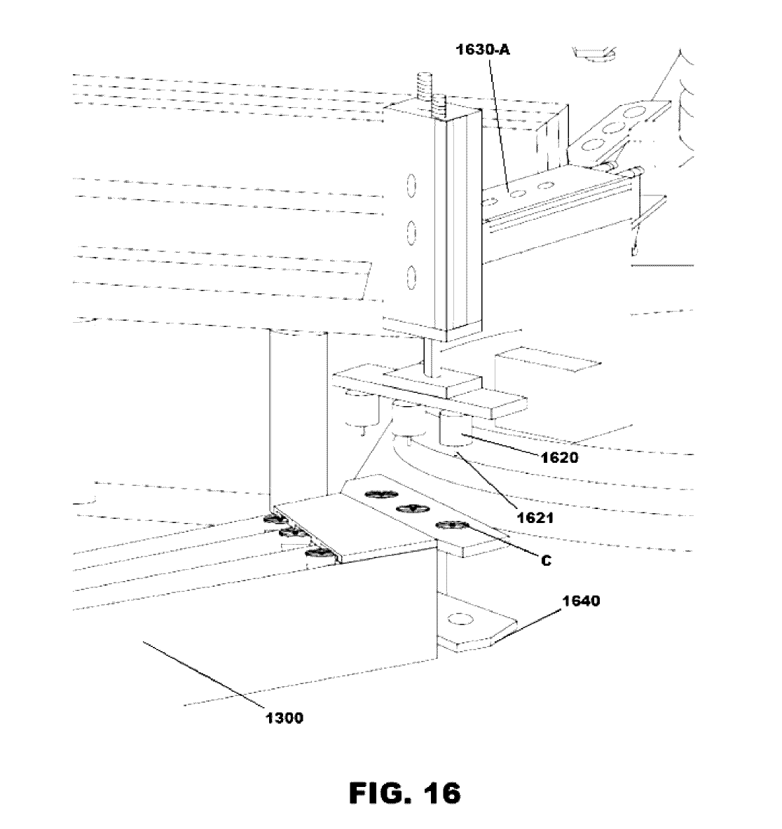

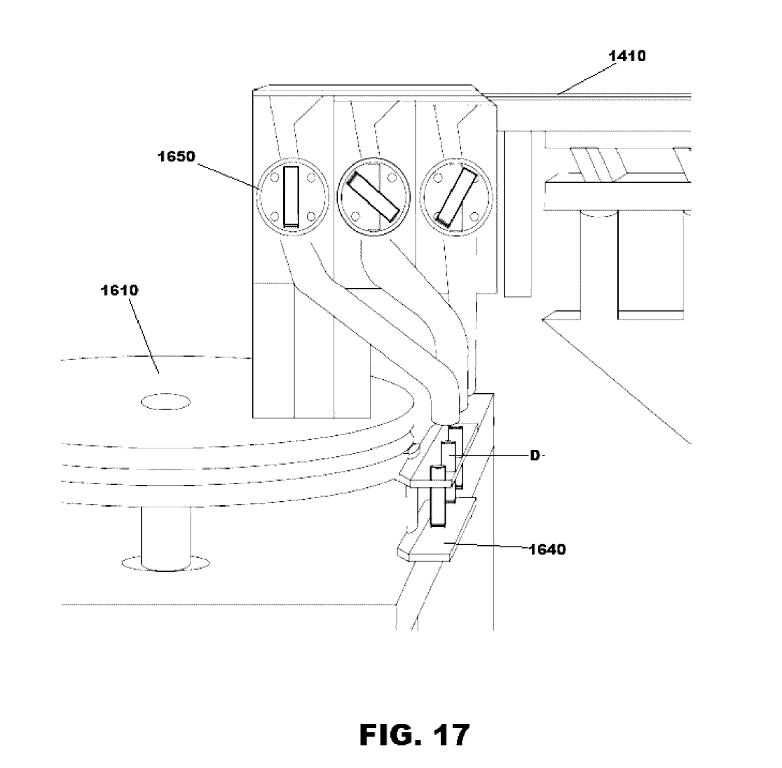

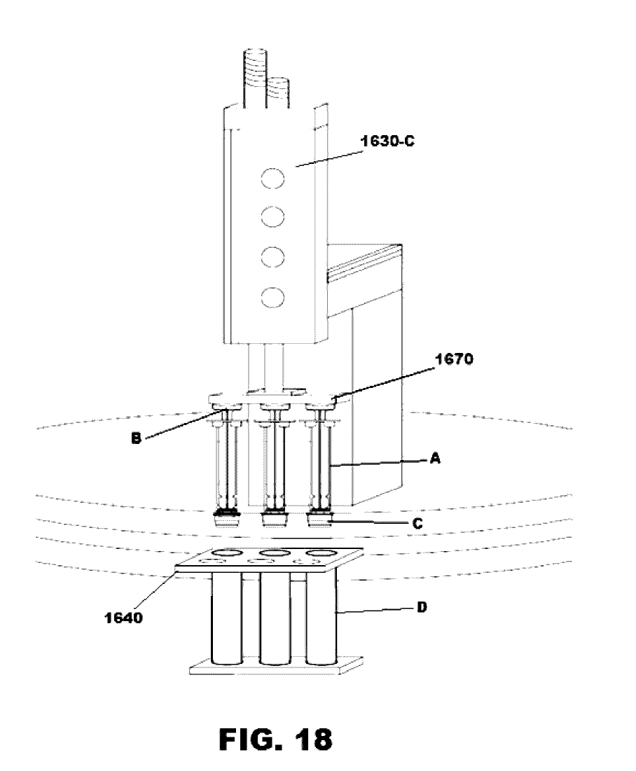

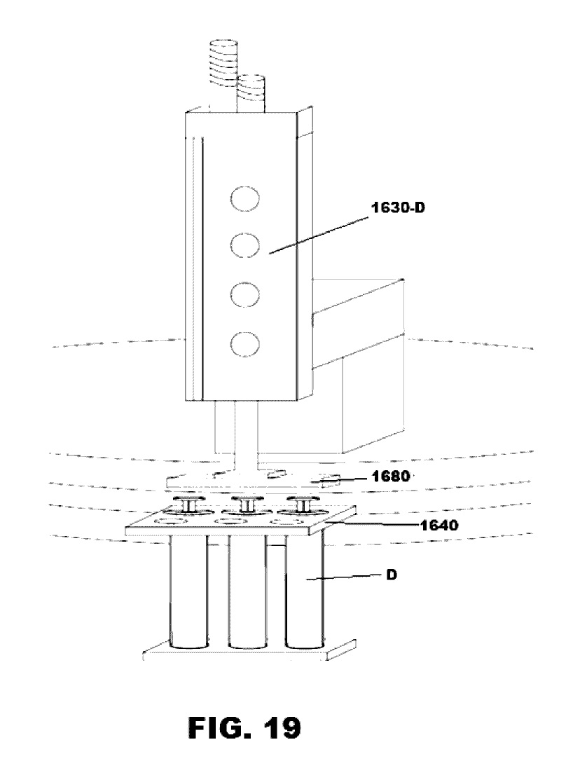

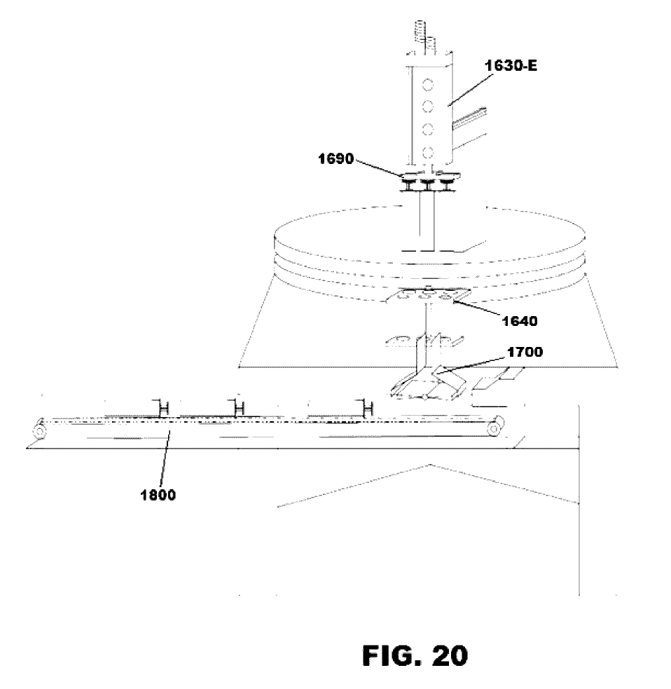

With respect now to FIGS. 15 to 20 the assembling process and operation of the machine is shown in a second phase of the assembling process in the rotating table 1610, wherein the first process of said second phase is performed at the station 1611 together with the vibratory feeder 1300 as shown in FIG. 16, the loading process of component C (adapter or Reverse), as shown in said FIG. 16, said component C is inserted into the cavities conveyor plate 1640, by means of a sets of drums 1620 with projections 1621 holding by adjustment to said components C, which are lowered and inserted, by means of pressure, into the cavities conveyor plate 1640 by means of an actuator or mini-carriage 1630A; simultaneously at station 1612 together with the vibratory feeder 1400 as shown in FIG. 17, the loading process of component D (Room or hood type bullet or flat) is performed, said component is placed by gravity on the cavities conveyor plate 1640, its position on the plate should be with the fitting diameter upward oriented, since if the position is not that mentioned above, said position can be obtained by a system composed by three dividing plates 1650, wherein each plate has a photocell which detects the position of the component D (Housing or hood having a bullet or flat shape), that is to say, if component D (Housing or hood having a bullet or flat shape) has fallen with the fitting diameter downward oriented the dividing plate 1650 performs a turn of 180° to position the component D (Housing or hood having a bullet or flat shape) with the fitting diameter upward oriented; at station 1613 it is not generated any process, which indicates the machine that the above mentioned processes have been completed and that it is possible to start the process of inserting the component C (adapter or Invested) at station 1614 together with the station 1517, as well as the process of partial insertion of component D (Room or hood bullet or flat) at station 1615, as well as the full insertion of component D (Room or hood bullet or flat), with the component A (Syringe with pivot), component B (plunger or piston) and component C (adapter or Inverted) already assembled, which will be explained below; subsequently, once inserted components C in the cavities conveyor plate 1640, these are transported and passed through a pair of stations to reach the station 1614 wherein in this station together with station 1517, the insertion process of the component C (adapter or inverted) onto the nozzle or pivot of component A (Syringe with pivot) with component B (plunger or piston) already assembled takes place, as shown in FIG. 15, the insertion of said component C (adapter or inverted) is performed as mentioned, with component a (Syringe with pivot) and component B (plunger or piston) already assembled, for this process the station 1614 is related with station 1517, that is to say, component A (Syringe with pivot) and component B (plunger or piston) already assembled are taken directly from the cavities conveyor plate 1540 to station 1517 through a sets of vacuum generators 1660, then they are transported by means of a pair of actuators or mini-carriages 1630A and positioned and inserted into the component C (adapter or Inverted); later at station 1615 the process of partial insertion of component D (Housing or hood having a bullet or flat shape) on component A (Syringe with pivot) with component B (Plunger or piston) and the component C (adapter or inverted) already assembled is performed, as shown in FIG. 18, this process is performed by a sets of vacuum generators 1670 holding the component a (Syringe with pivot), with component B (plunger or piston) and component C (adapter or Inverted) already assembled, which are transported and placed by a mini-actuator or carriage 1630C towards the interior of the fitting diameter of component D (Housing or hood having a bullet or flat shape); subsequently in station 1616, the process of full insertion of component D (Housing or hood having a bullet or flat shape) on component A (Syringe with pivot) with component B (Plunger or piston) and component C (adapter or inverted) already assembled is performed as shown in FIG. 19, this process is performed by a plate 1680 which is lowered by means of an actuator or mini-carriage 1630D and which generates the full insertion of component A (Syringe with pivot), with component B (plunger or piston), and component C (adapter or Invested) already assembled into component D (Housing or hood having a bullet or flat shape); at station 1617 any process is not generated, this station is maintained free to indicate the machine that the above processes have been completed and that the last process of the second phase of the assembling process can be performed, wherein said assembling process is performed at station 1618; in said station 1618 is carried out the final process of downloading and transporting the oral medicament dispenser (E) fully assembled, as shown in FIG. 20, this process is performed by means of vacuum generators 1690 holding the oral medicament dispenser (E) and transport it, locate it and download it by gravity, toward a gate 1700 which is positioned towards a conveyor belt 1800, with which the oral medicament dispenser (E) reach the container of the finished product (not shown).

In a further embodiment of the present invention, the assembling machine of oral medicament dispensers is also designed to assemble oral medicament dispensers without component C. For assembling the oral drug dispenser (E) without component C (adapter or inverted) the process is the following: firstly the vibratory feeder of component C (adapter or inverted) 1300 is disabled and in all and each one of the cavities conveyor plates 1640 stainless steel pieces with the same shape to that of component C (adapter or inverted) are placed under pressure, which are placed so that the sets of photocells, which are located at the end of the track in line and curve 1310, detect the presence of said stainless steel pieces like if it were the component C (adapter or inverted), so that the machine continues its normal process obtaining oral medicament dispensers (E) without component C (adapter or inverted).

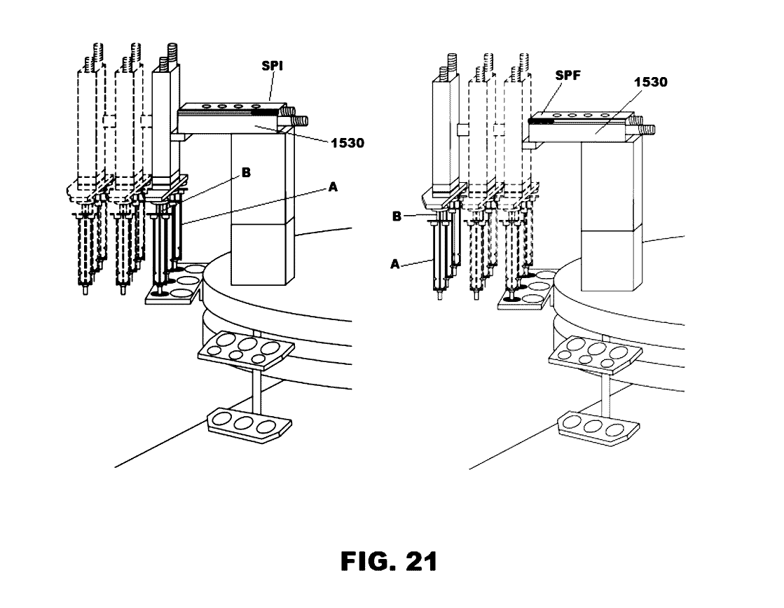

With respect to FIG. 21 the operation of the actuators or mini-carriages 1530 and 1630 for assembling the oral medicament dispensers is shown. The machine 1000 is composed by a total of 93 position sensors, which are installed in various parts of said machine 1000 and in all the actuators or mini-carriages. Said actuators or mini-carriages are activated by two motion sensors SPI and SPF, the first SPI motion sensor is located at the proximal end of the actuator or mini-carriage, this position is specified as the starting position, the second SPF motion sensor is located in the distal end of the actuator or mini-carriage, this position is specified as the final position, as shown in FIG. 21 wherein it could be observed an example with the station 1517, wherein the translation of component A (Syringe with pivot) with component B (Plunger or piston) already assembled is performed, said translation is made from the rotating plate 1510 to the rotating plate 1610.

On the other hand, in order that the actuators or mini-carriages 1530 and 1630 are activated, a signal to each of the motion sensors should be issued and that signal is emitted by a total of five sets of photocells, wherein each of said sets is composed of three photocells, the first set of photocells is located at the end of the track in line and curve 1110, that is to say the set of photocells detects if the component A (Syringe with pivot) is present, to emit the signal to the motion sensor in the starting position SPI of the actuator or mini-carriage 1530A, to load said component A (Syringe with pivot) on the cavities conveyor plate 1540, subsequently when the actuator or mini-carriage 1530 returns again to the motion sensor in the starting position SPI, said sensor emits another signal to the asynchronous motor MA together with the gear motor MR of the rotating plates 1510 and 1610 so that they can rotate and pass to the cavities conveyor plate together with component A (Syringe with pivot) to the next station and the next process can be made; the second sets of photocells is located at the end of the track in line and curve 1210, ie the set of photocells detects if the component B (Plunger or piston) is present, to emit the signal to the motion sensor at starting position SPI of the actuator or mini-carriage 1530D to load and insert said component B (Plunger or piston) into the component A (Syringe with pivot) subsequently when the actuator or mini-carriage 1530-D, returns again to the motion sensor in starting Position SPI, said sensor emits another signal to the asynchronous motor MA together with the gear motor MR of the rotating plates 1510 and 1610 so that they can rotate and pass to the cavities conveyor plate together with component A (Syringe with pivot) and component B (Plunger or piston) already assembled to the next station and the next process can be made; the third set of photocells is located at the end of the track in line and curve 1310, ie the set of photocells detects if the component C (adapter or Invested) is present, to emit the signal to the motion sensor in Starting Position SPI of the actuator or mini-carriage 1630A to load and insert said component C (adapter or Invested) on the cavities conveyor plate 1640, then, when the actuator or mini-carriage 1630A, returns again to the motion sensor in Starting Position SPI, said sensor emits another signal to the asynchronous motor MA together with the gear motor MR of the rotating plates 1510 and 1610 so that they can rotate and pass to the cavities conveyor plate 1640 together with component C (adapter or Invested) to the next station and the following process can be made; the fourth set of photocells is located in the system composed of three dividing plates 1650 wherein each plate comprises a photocell, ie the set of photocells detects if the component D (Housing or hood having a bullet or flat shape), is present, likewise it also detects the position in which said component falls, ie if the component D (Housing or hood having a bullet or flat shape) has fallen with the fitting diameter downward oriented in this case, the divider plate 1650 performs a turn of 180° to position the component D (Housing or hood having a bullet or flat shape) with fitting diameter upward oriented, when the presence and correct position of the component D is detected, the photocell emits a signal to a small gate to drop the component by gravity towards the cavities conveyor plate 1640; finally, the fifth and last set of photocells detects if the component D (Housing or hood having a bullet or flat shape) is present, said photocell emits a signal to the asynchronous motor MA together with the gear motor MR of the rotating plates 1510 and 1610 so that they can turn and pass to the cavities conveyor plate 1640 together with component D (Housing or hood having a bullet or flat shape) to the next station and the following process can be made.

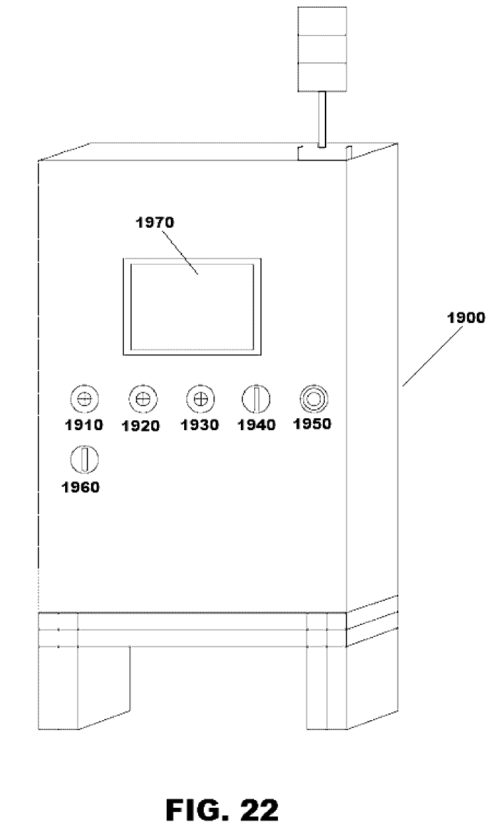

With respect to FIG. 22, a PLC (Programmable Logic Controller) 1900 of the machine 1000 is shown which is expanded with eight blocks, four outputs blocks and input four blocks, and which is generally programmed with logic sequence; this system is located inside a control board which is controlled by a touch screen monitor 1970.

The control panel besides said touch screen 1970 also comprises the following drivers: a button of CONTROL ON 1910 which is configured to energize all THE stations, a button of CONTROL OFF 1920, which is configured to de-energize all the stations, a button of RESET/FAIL 1930, which is configured to re-establish the system due to any failure that had occurred during the process and the machine 1000 has stopped, a selector MANUAL/AUTOMATIC 1940, which it is configured to select the way in which the operation of the machine 1000 is required, ie we can make manually a movement in each of the stations of the machine 1000 and automatically we can start the process of all and each one of the stations, equally said control panel also comprises a mushroom shape button of EMERGENCY 1950, which is configured to completely stop the machine 1000 during any process or any circumstance that occurs, and a selector of SECURITY 1960, this driver is to activate the security guards to avoid any accident, ie if the security guard is opened the machine stops completely.

In order to start with the assembly of the oral medicament dispenser (E) it should begin with the feeding of components in the vibratory feeders, which are conformed as follows: a vibratory feeder for component A (Syringe with pivot) 1100, a vibratory feeder for component B (Plunger or piston) 1200, a vibratory feeder for component C (adapter or inverted) 1300 and a vibratory feeder for component D (Housing or hood having a bullet or flat shape) 1400, subsequently after feeding all and each one of the components, the operator should be placed in the MANUAL/AUTOMATIC selector 1940 and select MANUAL, then select in the touch screen 1970 VIBRATORY FEEDERS, then, the four feeders corresponding to the component A, B, C and D are presented, selecting one by one at the final position to activate the vibration, these components will be uploaded and accommodated until the end of the tracks in line and curve 1110, 1210, 1310 and 1410 respectively, later, once the feeders and tracks are uploaded online, select from the MANUAL/AUTOMATIC 1940 selector AUTOMATIC and on the touch screen 1970 select then START PROCESS to begin with the processes in all and each one of the stations and thereby obtain the assembled oral medicament dispensers (E).

1. A modular automated machine for assembling oral medicament dispensers conformed by: a component A (Syringe with pivot); a component B (Plunger or piston); a component C (adapter or Invested); and a component D (hosing or hood having a bullet or flat shape), wherein said machine comprises: a pair of central tables, each table having a rotating plate for receiving separately the components of the oral medicament dispenser, by means of a plurality of vibratory feeders arranged in a modular or planetary manner around said pair of central tables, said vibratory feeders, comprising a track in line and curve, for feeding a respective component of the oral medicament dispenser to the corresponding table; each rotating plate comprises a plurality of workstations pneumatically actuated, in which a set of processes or operations for assembling the oral medicament dispenser are performed by a plurality of actuators or mini-carriages pneumatically actuated and activated by motion sensors by means of a set of photocells located therein, and a plurality of cavities conveyor plates located on the periphery of said rotating plates to rotate along with the same, wherein said workstations are disposed peripherally around said rotating plates, wherein the first table comprising workstations to perform the processes of: loading of component A; torching the inner walls of said component A; siliconizing the inner walls of component A; loading and inserting partially said component B into component A; inserting fully said component B into component A; flaming component A and component B already assembled; inserting component C on pivot of component A with component B into the same, together with the corresponding station of the second table; indicating the machine by means of said sensor that the previous processes have been completed and that another cycle of processes can be started, wherein the second table includes workstations to perform the processes of: loading component C; loading component D in one of said cavities conveyor plates, with the fitting diameter upward oriented; indicating the machine by means of said sensors that the processes performed in the previous stations have been completed and that can a new process of loading and inserting partially said component C and component D can be started; inserting component C on pivot of component A with the component B within the same, together with the corresponding station of the first table; inserting partially component D with component A, component B and component C already assembled; inserting fully component D with component A, component B and component C already assembled; indicating the machine by means of said sensor that the previous processes have been completed and that the last process of unloading and transporting the oral medicament dispenser fully assembled to the container of finished product can be made.

2. The modular automated machine according to claim 1, wherein said tracks in line and curve are configured to support the flow of product while said product is moved through its parts by vibration, said tracks also comprises special coatings which help to prevent traction, product damage and to reduce noise levels and even for improving the efficiency in the components feeding, said tracks in line and curve further comprises air jets and supports whose function is to push the components with the same force of the air.

3. The modular automated machine according to claim 2, wherein said vibratory feeder further comprises a substantially cylindrical hopper; a support table for supporting said tracks in line and curve and said hopper; tubular supports, which are embedded or fixed on a solid base, which is supported at a point on the same table.

4. The modular automated machine according to claim 1, wherein said central tables have a substantially square shape, or any other suitable shape, said central tables are adjacent one to another and offset in height to their interaction during assembling process of the oral medicament dispenser.

5. The modular automated machine according to claim 1, wherein said rotating plates are connected pivotably to said tables by a shaft respectively, wherein said rotating plates perform movements of 45° through said shafts, wherein each movement or rotation is effected each time the last of the processes of each of said rotating plates has been completed, which rotate simultaneously at the same speed and independently, each of said rotating plates rotate by means of a system comprising a reduction unit which is coupled to an asynchronous standardized motor, said system is located below each of said tables.

6. The modular automated machine according to claim 1, wherein said cavities conveyor plates are correspondent with each workstation to perform each process.

7. The modular automated machine according to claim 1, wherein the loading of component A is performed using a parallel grippers which hold internally said component A, once said component A is hold, this is elevated by means of a pair of actuators or mini-carriages which place said component A on the respective cavities conveyor plate; once placed said components A on the plate, these are transported by a counterclockwise rotating movement of the rotating plate to the next station.

8. The modular automated machine according to claim 1, wherein the torching process consisting of applying ionized air to the internal walls of component A, said ionized air is applied to said internal walls by means of blowers through nozzles, said ionized air is fed to these blowers through flexible ducts, during said torching process, the nozzles are lowered by an actuator or mini-carriage and blow said ionized air into the component A, carrying out said torching process, components A are transported rotationally in a counterclockwise manner to the next station.

9. The modular automated machine according to claim 2, wherein the siliconizing process to the inner walls of component A is carried out by applying silicone by spray valves which are supplied by flexible ducts, wherein the silicone circulates through said spray valves via an inner conduit and is dispersed to the inner walls of component A through a plurality of ports or orifices, said valves are descended by an actuator or mini-carriage and apply a silicone light coating into the component A.

10. The modular automated machine according to claim 1, wherein the loading and insertion partial of component B is performed together with the respective vibratory feeder, wherein said component B is placed and partially inserted into component A which has been transported rotationally on the respective cavities conveyor plate by means of the rotating plate, said process is performed firstly by a set of vacuum generators holding and transport, by means of the actuator or mini carriage, said component B from the tracks in line and curve towards the component A and secondly by inserting partially said component B into said component A; in addition, said components A and B partially coupled or inserted are transported by the cavities conveyor plate to the next station to perform the process of full insertion of component B into component A, this process is performed by a plate lowered by an actuator or mini-carriage and generates the full insertion of component B into component A.

11. The modular automated machine according to claim 10, wherein subsequently components A and B already fully assembled are transported to the next station to perform the flaming process thereof, said flaming process is applied by heat guns to the outer walls of the components in their upper, lower and central parts.

12. The modular automated machine according to claim 1, wherein the insertion process of component C on the pivot of component A with component B already assembled, is performed by translating said components A and B from the rotating plate of the first table to the rotating plate of the second table wherein component A and component B already assembled from the first rotating plate, are taken from the cavities conveyor plate of said first plate by a set of vacuum generators, subsequently they are transported toward the rotating plate of the second table, then said assembled components A and B are positioned and inserted into the component C located on a cavities conveyor plate, which has transported said component C from the loading and insertion process of component C from the respective station; subsequently in said second table, the processes and assembly are finished at the next station, in which is not generated any process, since this station is maintained free to indicate the machine that the previous processes have been completed and it is possible to perform the beginning of another cycle of processes and assemblies from the first station of the first rotating plate.

13. The modular automated machine according to claim 1, wherein the loading process of component C is performed together with the respective vibratory feeder, said component C is inserted into the respective cavities conveyor plate through a set of drums with projections holding by adjustment said components C, which are lowered and by pressure are inserted into the cavities conveyor plate by means of an actuator or mini-carriage.

14. The modular automated machine according to claim 1, wherein at a further station together with the vibratory feeder of the component D the loading of component D is performed, which is positioned by means of the gravity force on the respective cavities conveyor plate, its position on the plate should be with the fitting diameter upward oriented, since if the position is not the latter, the correct position can be obtained by a system conformed by three dividing plates wherein each has a photocell which detects the position of component D, ie if the component D has fallen with the fitting diameter downward oriented, the dividing plate makes a turn of 180° to position component D with the fitting diameter upward oriented.

15. The modular automated machine according to claim 1, wherein in a further station any process is generated, which indicates the machine that the previous processes have been completed and that the insertion process of component C at the next station together with the respective station of the first table can be performed as well as the process of partial insertion of component D in the next station, and the full insertion of component D with component A, component B and component C already assembled; once inserted said components C in the cavities conveyor plate, these are subsequently transported and passed through a pair of stations to reach a fourth season of the rotating plate of the second table together with a seventh station of the rotating plate of the first table, to perform the insertion process of the component C onto the nozzle or pivot of component A with component B already assembled.

16. The modular automated machine according to claim 1, wherein in a fifth station of the rotary plate of the second table the process of partial insertion of component D into the component A, with component B and component C already assembled is performed, this process is performed by a set of vacuum generators holding the component A, with component B and component C already assembled, which are transported and placed by means of an actuator or mini-carriage towards the interior of the fitting diameter of component D; then at the next station the process of full insertion of component D into component A, with component B and component C already assembled is performed, this process is performed by a plate which is lowered by means of an actuator or mini-carriage and generates full insertion of component A with component B and component C already assembled within component D.

17. The modular automated machine according to claim 2, in a further station any process is generated, this station is maintained free to indicate the machine that the previous processes have been completed and that the last one can be performed; in said station the final process of unloading and transport of the oral medicament dispenser fully assembled is completed, said process is carried out by means of vacuum generators which hold the oral medicament dispensing and move, locate and downloading it by gravity, towards a gate which is positioned towards a conveyor belt, with which the oral medicament dispensers reach the finished product container.

18. The modular automated machine according to claim 1, wherein said machine is also designed to assemble oral medicament dispensers without component C, wherein in a first step the vibratory feeder of the component C is disabled and in all and each one of the cavities conveyor plate stainless steel parts with the same shape to that of component C are placed by pressure, which are placed so that the set of photocells that are located at the end of the track in line and curve of component C detect presence of said stainless steel parts as if the component C were present, so that the machine continues its normal process of getting oral medicament dispensers without the component C.

19. The modular automated machine according to any of the preceding claims, wherein the machine is composed of a total of 93 position sensors, which are installed in various parts of the machine and in all of the actuators or mini-carriages.

20. The modular automated machine according to any of the preceding claims, wherein said actuators or mini-carriages are activated by two motion sensors, the first motion sensor is located at the proximal end of the actuator or mini-carriage, this position being specified as the starting position, the second motion sensor is located at the distal end of the actuator or min-carriage, this position being specified as the final position.

21. A method of assembling oral medicament dispensers conformed by: an component A (Syringe with pivot); a component B (Plunger or piston); a component C (adapter or Inverted); and a component D (housing or hood having a bullet or flat shape), wherein said method in a first phase comprises the steps of: loading component A on a respective cavities conveyor plate by means of parallel grippers and a pair of actuators by a counterclockwise rotation movement of a rotating plate of a first table; torching the internal walls of component A by applying ionized air thereto, said ionized air is applied to said internal walls by blowers through nozzles; transporting the torched components A to the next station; siliconizing the internal walls of component A by applying silicone by means of spray valves; loading component B on a respective cavities conveyor plate from a vibratory feeder of component B; partially inserting said component B into component A through a set of vacuum generators holding and transporting, by a actuator or mini-carriage, said component B to the component A for its insertion into the same; translating said components A and B partially coupled or inserted through the cavities conveyor plate to the next station; fully inserting component B into component A, by a plate that is lowered by means of an actuator or mini-carriage; flaming said components A and B fully assembled by means of heat guns; inserting component C on the pivot of component A with component B already assembled by translating said components A and B from the rotating plate of the first table to a rotating plate of a second table wherein component A and component B already assembled from the first rotating plate, are taken from the cavities conveyor plate of said first plate, by a set of vacuum generators, are then are transported toward the rotating plate of the second table, and then said assembled components A and B are positioned and inserted into the component C located in a cavities conveyor plate which has conveyed component C from a loading and insertion process of component C of the respective station in the second table; indicating the machine that the previous processes have been completed and that it is possible to start another cycle of processes and assemblies from the first station of the first rotating plate, wherein in a second phase, the method comprises the steps of: loading component C together with the vibratory feeder of component C, wherein said component C is inserted into a respective cavities conveyor plate, by means of a set of drums with projections holding by an adjustment said component C which is lowered and inserted by pressure into the cavities conveyor plate by means of an actuator or mini-carriage; loading component D together with the vibratory feeder of component D which is positioned by gravity on the respective cavities conveyor plate, wherein its position on the plate should be with the fitting diameter upward oriented, wherein if the position is not the latter, this position is corrected by a system composed by three dividing plates wherein each dividing plate comprising a photocell which detects the position of component D, wherein if the component D has fallen with the fitting diameter downward oriented, the dividing plate makes a turn of 180° to position said component D with the fitting diameter upward oriented; indicating the machine that the previous processes have been completed and that the process of inserting component C at the next station together with the respective station of the first table can be performed, as well as the process of partial insertion of component D in the next station, and the full insertion of component D with component A, component B and component C already assembled; transporting the components C to the next station of the rotating plate of the second table which together with a seventh station of the rotating plate of the first table, carries out the insertion process of component C on the nozzle or pivot of component A with component B already assembled; partially inserting component D on component A with component B and component C already assembled by means of a set of vacuum generators holding the component A, component B and component C already assembled, which are transported and placed by an actuator or mini-carriage towards the interior of the fitting diameter of component D; fully inserting the component D onto the component A, with component B and component C already assembled, by a plate which is lowered by means of an actuator or mini-carriage and generates the full insertion of component A with component B and component C already assembled into component D; indicating the machine that the previous processes have been completed and that the last process can be performed; downloading and transferring the oral medicament dispenser fully assembled, using vacuum generators which hold the oral medicament dispenser and transfer, locate and download it by gravity, towards a gate which is positioned towards a conveyor belt, with which the oral medicament dispenser reaches the finished product container.
